(19) United States
(12) Patent Application Publication
(10) Pub. No.: US 2017/0325014 A1
(43) Pub. Date: Nov. 9, 2017

(54) DUAL AUDIO EARPHONE

(71) Applicant: Chi-Cheng WEN, Taoyuan City (TW)

(72) Inventor: Chi-Cheng WEN, Taoyuan City (TW)

(21) Appl. No.: 15/201,478

(22) Filed: Jul. 3, 2016

(30) Foreign Application Priority Data
May 9, 2016 (TW) 105206653

(51) Int. Cl. H04R 1/10; H04R 17/00

(52) U.S. Cl. CPC H04R 1/1016; H04R 17/00

(57) ABSTRACT

A dual audio earphone contains: an enclosure and a speaker unit. The enclosure includes a first chamber in which the speaker unit is housed, between a sound output end of the speaker unit and the enclosure is defined a cavity, the enclosure also includes a sound hole, and the speaker unit includes a holder, a dynamic speaker, a piezoelectric speaker, and a circuit unit. The holder has a bottom, a peripheral fence surrounding the bottom so as to form a second chamber, and an opening. The piezoelectric speaker is housed in the opening, and between the piezoelectric speaker and the sound hole is defined the cavity. The dynamic speaker is accommodated in the second chamber and is located between the piezoelectric speaker and the bottom, and the circuit unit is arranged outside the holder and is electrically connected with the dynamic speaker and the piezoelectric speaker.

### FIELD OF THE INVENTION

The present invention relates to a dual audio earphone which contains a dynamic speaker and a piezoelectric speaker.

### BACKGROUND OF THE INVENTION

A conventional electroacoustic converter (earphone 100) has an enclosure 41, piezoelectric sounding body 32, electromagnetic sounding body 31, and passage 35. The piezoelectric sounding body 32 includes a first vibration plate 321 having a periphery supported directly or indirectly on the enclosure 41, and a piezoelectric element 322 placed at least on one side of the vibration plate 321. The piezoelectric sounding body 32 has a second vibration plate and divides the interior of the enclosure 41 into a first space S1 and a second space S2. The electromagnetic sounding body 31 is placed in the first space S1. The passage 35 is provided in or around the piezoelectric sounding body 32 to connect the first space S1 and second space S2.

However, the earphone 100 is complicated and is assembled troublesomely, thus having high production cost. Furthermore, the earphone 100 is broken easily and makes sounds poorly.

The present invention has arisen to mitigate and/or obviate the afore-described disadvantages.

### SUMMARY OF THE INVENTION

The primary objective of the present invention is to provide a dual audio earphone which is simplified so as to reduce production cost and enhances sound quality.

To obtain above-mentioned objective, a dual audio earphone provided by the present invention contains: a hollow enclosure and a speaker unit.

The enclosure includes a first chamber defined therein, the speaker unit is housed in the first chamber of the enclosure, and between a sound output end of the speaker unit and the enclosure is defined a cavity, the enclosure also includes a sound hole communicating with the cavity.

The speaker unit includes a holder, a dynamic speaker, a piezoelectric speaker, and a circuit unit.

The holder has a bottom and a peripheral fence surrounding the bottom so as to form a second chamber in the holder, and the holder also has an opening facing the cavity, the piezoelectric speaker is housed in and flushes with the opening of the holder, and between the piezoelectric speaker and the sound hole of the enclosure is defined the cavity, the dynamic speaker is accommodated in the second chamber and is located between the piezoelectric speaker and the bottom of the holder, the dynamic speaker and the piezoelectric speaker send sounds to the sound hole of the enclosure, and the circuit unit is arranged outside the bottom of the holder and is electrically connected with the dynamic speaker and the piezoelectric speaker.

Preferably, the enclosure further includes a sound hose and an ear covering, and the sound hose is in communication with the first chamber via the sound hole, the ear covering is fitted on the sound hose.

Preferably, a dust-proof element is fixed on an outlet end of the sound hose.

Preferably, the enclosure including a first part and a second part, and the sound hole is arranged on the first part.

Preferably, the bottom of the holder has at least two through orifices which are in communication with the second chamber of the holder and the first chamber of the enclosure.

Preferably, the dynamic speaker includes a drive unit and a vibration film, the drive unit has a magnet and an electromagnetic coil, and the magnet is fixed in the second chamber of the holder and on the bottom, the electromagnetic coil is fitted on the magnet, and the vibration film is mounted in the second chamber of the holder and has a fixing element configured to fix the vibration film on an inner surface of the holder, and an inner surface of the vibration film connects with the electromagnetic coil, a head end of the electromagnetic coil extends through the holder so as to electrically couple with the circuit unit.

Preferably, the holder includes a mounting element secured in the second chamber of the holder and defined between the dynamic speaker and the piezoelectric speaker so as to retain with the piezoelectric speaker, and the piezoelectric speaker is separated from the vibration film.

Preferably, the mounting element is annular and contacts with an inner surface of the peripheral fence of the holder.

Preferably, the piezoelectric speaker includes a protective cap and at least one piezoelectric ceramic element, the protective cap is retained in the opening of the holder and flushes with the opening, a profile of the protective cap corresponds to the opening, and the at least one piezoelectric ceramic element is housed in the opening, wherein the protective cap has multiple apertures which are arranged around the at least one piezoelectric ceramic element and are symmetrical to a central position of the piezoelectric speaker.

Preferably, the second chamber has a first end proximate to the opening and has a second end opposite to the first end of the second chamber, and a diameter of the first end of the second chamber is greater than that of the second end of the second chamber.

### BRIEF DESCRIPTION OF THE DRAWINGS

FIG. 1 is a cross sectional view showing the assembly of a dual audio earphone according to a first embodiment of the present invention.

FIG. 2 is a perspective view showing the exploded components of a part of the dual audio earphone according to the first embodiment of the present invention.

FIG. 3 is a side plane view showing the assembly of a part of the dual audio earphone according to the first embodiment of the present invention.

FIG. 4 is a cross sectional view taken along the line A-A of FIG. 3.

FIG. 5 is another side plane view showing the assembly of a part of the dual audio earphone according to the first embodiment of the present invention.

FIG. 6 is also another side plane view showing the assembly of a part of the dual audio earphone according to the first embodiment of the present invention.

FIG. 7 is a perspective view showing the exploded components of a dual audio earphone according to a second embodiment of the present invention.

FIG. 8 is a cross sectional view showing the assembly of the dual audio earphone according to the second embodiment of the present invention.

### DETAILED DESCRIPTION OF THE PREFERRED EMBODIMENTS

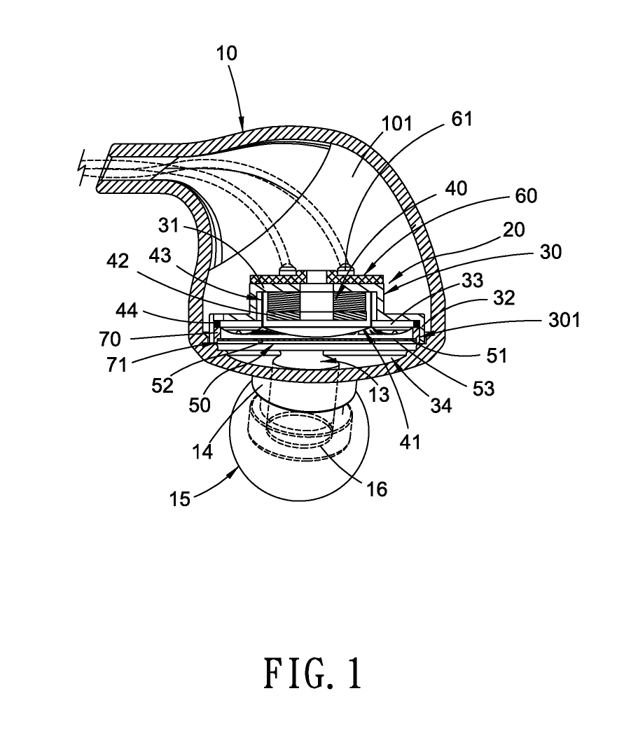

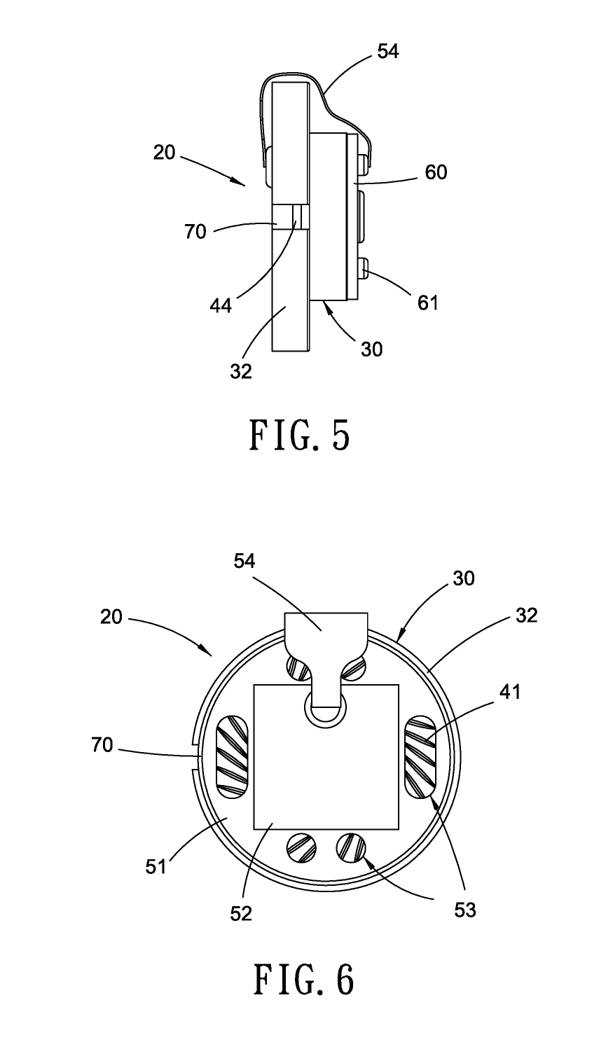

With reference to FIGS. 1-6, a dual audio earphone according to a first embodiment of the present invention comprises: a hollow enclosure 10 and a speaker unit 20.

The speaker unit 20 includes a holder 30, a dynamic speaker 40, a piezoelectric speaker 50, and a circuit unit 60. The dynamic speaker 40 and the piezoelectric speaker 50 are accommodated in the holder 30 so as to send sounds, and the circuit unit 60 is disposed on the holder 30 and is electrically connected with the dynamic speaker 40, the piezoelectric speaker 50, and an external tone circuit (such as a sound port on the dual audio earphone). The speaker unit 20 is housed in the enclosure 10, and between a sound output end of the speaker unit 20 and the enclosure 10 is defined a cavity 34.

In assembly, the dynamic speaker 40 is in connection with the piezoelectric speaker 50, and then the dynamic speaker 40 and the piezoelectric speaker 50 are accommodated in the enclosure 10. In one embodiment, the speaker unit 20 is embedded in a mold by way of a fixture, and glues are fed into the mold so as to integrally mold the enclosure 10 and to embed the speaker 20 in the mold precisely and quickly.

The enclosure 10 includes a first chamber 101 defined therein, a sound hole 13 communicating with the cavity 34, wherein the sound hole 13 is a sole hole or is comprised of a plurality of meshes. In this embodiment, the sound hole 13 is the sole hole. The enclosure 10 further includes a sound hose 14 and an ear covering 15 made of silicone rubber, wherein the sound hose 14 is in communication with the first chamber 101 via the sound hole 13, and the ear covering 15 is fitted on the sound hose 14. Preferably, a dust-proof element 16 is fixed on an outlet end of the sound hose 14.

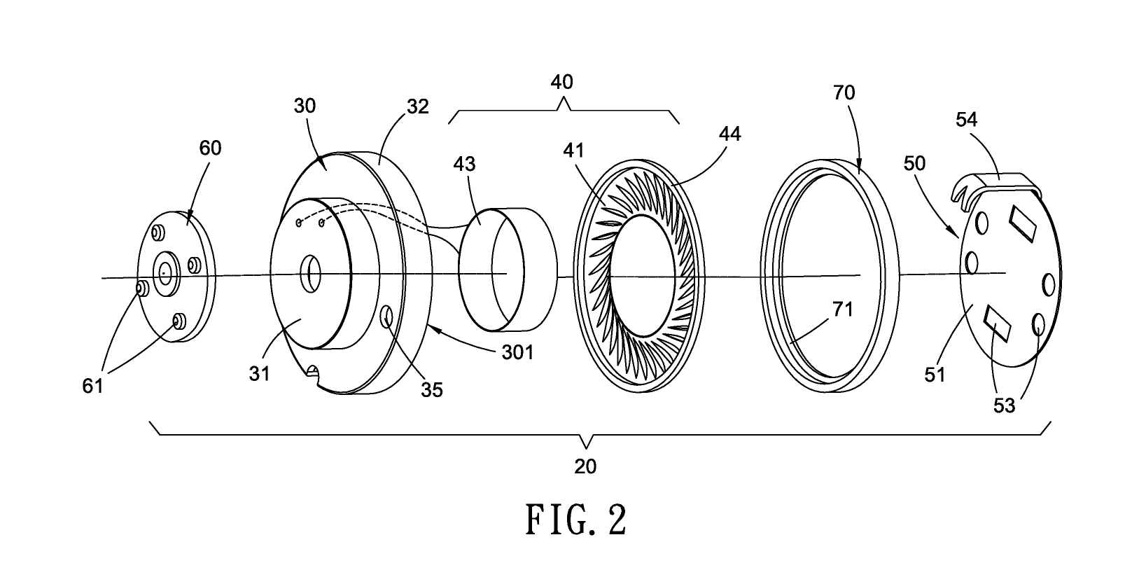

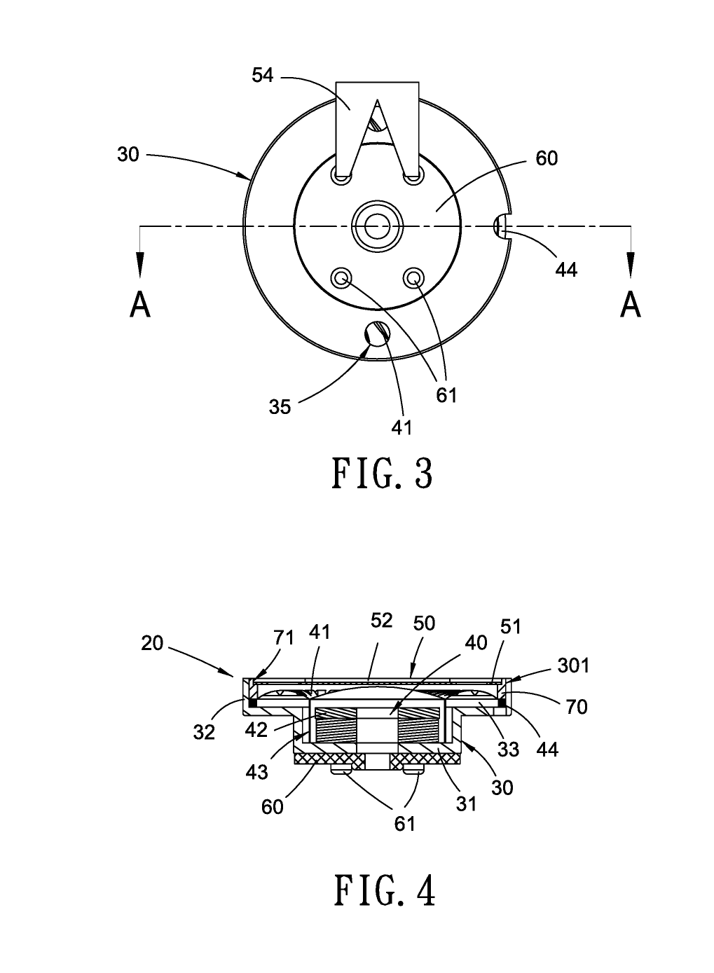

The holder 30 is injection molded from plastic material and has a bottom 31 and a peripheral fence 32 surrounding the bottom 31 so as to form a second chamber 33 in the holder 30, and the holder 30 also has an opening 301 facing the cavity 34, as shown in FIG. 2, wherein the second chamber 33 has a first end proximate to the opening 301 and has a second end opposite to the first end of the second chamber 33, and a diameter of the first end of the second chamber 33 is greater than that of the second end of the second chamber 33. The piezoelectric speaker 50 is housed in and flushes with the opening 301 of the holder 30, and between the piezoelectric speaker 50 and the sound hole 13 of the enclosure 10 is defined the cavity 34, the dynamic speaker 40 is accommodated in the second chamber 33 and is located between the piezoelectric speaker 50 and the bottom 31 of the holder 30. The circuit unit 60 is arranged outside the bottom 31 of the holder 30 and is electrically connected with the dynamic speaker 40, the piezoelectric speaker 50, and the external tone circuit. For example, the circuit unit 60 is electrically connected with an earphone wire and an earphone plug through a first circuit contact 61 (as illustrated in FIG. 3).

The piezoelectric speaker 50 is housed in the opening 301 of the holder 30, and the dynamic speaker 40 is accommodated in the second chamber 33 and is located between the piezoelectric speaker 50 and the bottom 31 of the holder 30, wherein the dynamic speaker 40 and the piezoelectric speaker 50 send the sounds to the sound hole 13 of the enclosure 10.

The dynamic speaker 40 is configured to produce the sounds in a bass range. The dynamic speaker 40 includes a drive unit and a vibration film 41, wherein the drive unit has a magnet 42 and an electromagnetic coil 43, and the magnet 42 is fixed in the second chamber 33 of the holder 30 and on the bottom 31. Preferably, the magnet 42 is directly fixed on the bottom 31 of the holder 30 (Alternatively, the magnet 42 is fixed on the bottom 31 of the holder 30 by using a support element) and is located at the second end of the second chamber 33, and between the magnet 42 and the peripheral fence 32 of the holder 30 is defined a gap. In addition, the electromagnetic coil 43 is fitted on the magnet 42 and is located at the gap, and the vibration film 41 is mounted in the second chamber 33 of the holder 30 and has a fixing element 44 (such as a copper ring) configured to fix the vibration film 41 on an inner surface of the holder 30, and the fixing element 44 is adhered on an inner surface of the peripheral fence 32 of the holder 30, an inner surface of the vibration film 41 faces the magnet 42 and connects with (i.e., adhered with) the electromagnetic coil 43, wherein a head end of the electromagnetic coil 43 extends through the holder 30 so as to electrically couple with the circuit unit 60 (for example, the head end of the electromagnetic coil 43 extends through the bottom 31 of the holder 30 so as to electrically couple with the circuit unit 60). Furthermore, the bottom 31 of the holder 30 has at least two through orifices 35 (as shown in FIG. 3) which are in communication with the second chamber 33 of the holder 30 and the first chamber 101 of the enclosure 10, such that when the vibration film 41 of the dynamic speaker 40 vibrates, a pressure in the second chamber 33 is changed so as to adjust the sounds.

The piezoelectric speaker 50 sends the sounds in a middle and treble range and includes a protective cap 51 and at least one piezoelectric ceramic element 52, wherein the protective cap 51 is retained in the opening 301 of the holder 30. Preferably, the protective cap 51 flushes with the opening 301 and its profile corresponds to the opening (for example, the protective cap 51 and the opening 301 are circular), such that the dynamic speaker 40 is protected by the protective cap 51 and the at least one piezoelectric ceramic element 52 is housed in the opening 301. The at least one piezoelectric ceramic element 52 is located beside one surface of the protective cap 51 facing to the sound hole 13 of the enclosure 10, wherein the at least one piezoelectric ceramic element 52 is located beside a central portion of the one surface of the protective cap 51, and the protective cap 51 has multiple apertures 53 which are circular or oval, and the multiple apertures 53 are arranged around the at least one piezoelectric ceramic element 52 and are symmetrical to a central position of the piezoelectric speaker 50, such that the sounds send to user's ear from the piezoelectric speaker 50 via the multiple apertures 53. Preferably, a shape and a size of each of the multiple apertures 53 are changeable so as to adjust the sounds. In addition, a number of the at least one multiple apertures 53 is changeable so as to adjust the sounds.

The holder 30 includes a mounting element 70 secured in the second chamber 33 of the holder 30 and defined between the dynamic speaker 40 and the piezoelectric speaker 50. Preferably, the mounting element 70 is annular and contacts with the inner surface of the peripheral fence 32 of the holder 30, wherein the mounting element 70 has a peripheral groove 71 defined therein so as to retain with the protective cap 51 of the piezoelectric speaker 50, and the piezoelectric speaker 50 is separated from the vibration film 41. Preferably, the piezoelectric speaker 50 has a printed circuit 54 electrically connected with the circuit unit 60, hence audio signals from the external tone circuit convert into the sounds at different frequencies, after the circuit unit 60 drives the dynamic speaker 40 and the piezoelectric speaker 50.

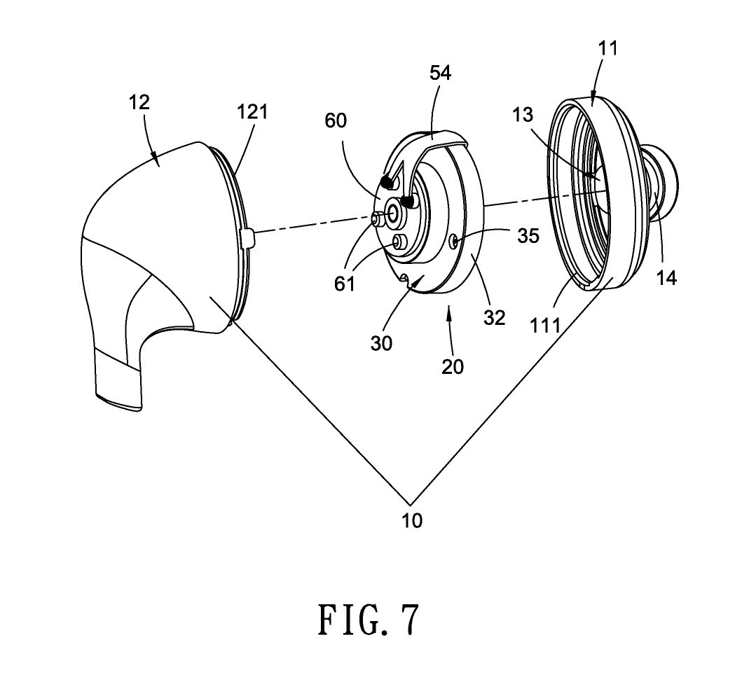

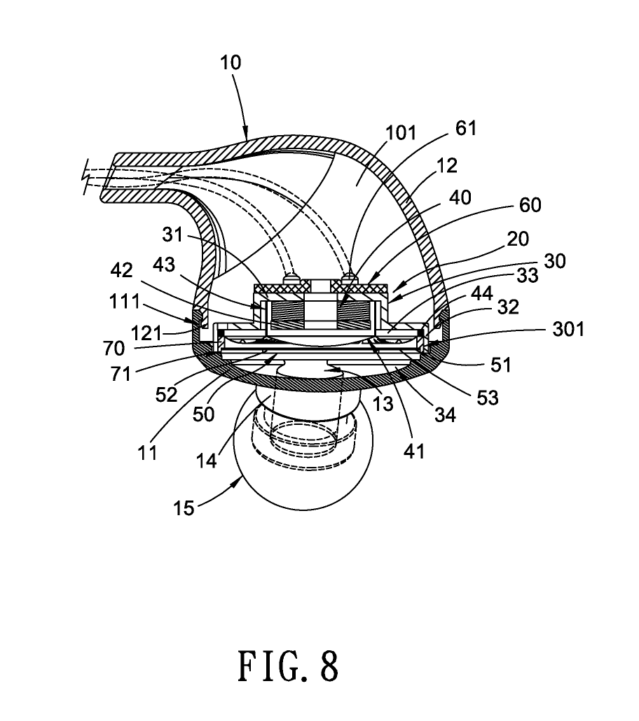

Referring to FIGS. 7 and 8, a difference of a dual audio earphone of a second embodiment from that of the first embodiment comprises: an enclosure 10 including a first part 11 and a second part 12, wherein the first part 11 is close to user's ear, a sound hole 13 is arranged on the first part 11, and the first part 11 and the second part 12 are injection molded from plastic material and are connected together. The second part 12 has a hook 121 formed on a mouth thereof, and the first part 11 has a locking recess 111 defined on a mouth thereof so as to retain with the hook 121, such that the second part 12 and the first part 11 are connected together. Furthermore, between a piezoelectric speaker 50 and the first part 11 is defined a cavity 34 which communicates with the sound hole 13 of the first part 11.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A dual audio earphone comprising: a hollow enclosure and a speaker unit;
the enclosure including a first chamber defined therein, the speaker unit being housed in the first chamber of the enclosure, and between a sound output end of the speaker unit and the enclosure being defined a cavity, the enclosure also including a sound hole communicating with the cavity;
the speaker unit including a holder, a dynamic speaker, a piezoelectric speaker, and a circuit unit;
wherein the holder has a bottom and a peripheral fence surrounding the bottom so as to form a second chamber in the holder, and the holder also has an opening facing the cavity, the piezoelectric speaker is housed in and flushes with the opening of the holder, and between the piezoelectric speaker and the sound hole of the enclosure is defined the cavity, the dynamic speaker is accommodated in the second chamber and is located between the piezoelectric speaker and the bottom of the holder, the dynamic speaker and the piezoelectric speaker send sounds to the sound hole of the enclosure, and the circuit unit is arranged outside the bottom of the holder and is electrically connected with the dynamic speaker and the piezoelectric speaker.

2. The dual audio earphone as claimed in claim 1, wherein the enclosure further includes a sound hose and an ear covering, and the sound hose is in communication with the first chamber via the sound hole, the ear covering is fitted on the sound hose.

3. The dual audio earphone as claimed in claim 2, wherein a dust-proof element is fixed on an outlet end of the sound hose.

4. The dual audio earphone as claimed in claim 1, wherein the enclosure including a first part and a second part, and the sound hole is arranged on the first part.

5. The dual audio earphone as claimed in claim 1, wherein the bottom of the holder has at least two through orifices which are in communication with the second chamber of the holder and the first chamber of the enclosure.

6. The dual audio earphone as claimed in claim 1, wherein the dynamic speaker includes a drive unit and a vibration film, the drive unit has a magnet and an electromagnetic coil, and the magnet is fixed in the second chamber of the holder and on the bottom, the electromagnetic coil is fitted on the magnet, and the vibration film is mounted in the second chamber of the holder and has a fixing element configured to fix the vibration film on an inner surface of the holder, and an inner surface of the vibration film connects with the electromagnetic coil, a head end of the electromagnetic coil extends through the holder so as to electrically couple with the circuit unit.

7. The dual audio earphone as claimed in claim 4, wherein the dynamic speaker includes a drive unit and a vibration film, the drive unit has a magnet and an electromagnetic coil, and the magnet is fixed in the second chamber of the holder and on the bottom, the electromagnetic coil is fitted on the magnet, and the vibration film is mounted in the second chamber of the holder and has a fixing element configured to fix the vibration film on an inner surface of the holder, and an inner surface of the vibration film connects with the electromagnetic coil, a head end of the electromagnetic coil extends through the holder so as to electrically couple with the circuit unit.

8. The dual audio earphone as claimed in claim 6, wherein the holder includes a mounting element secured in the second chamber of the holder and defined between the dynamic speaker and the piezoelectric speaker so as to retain with the piezoelectric speaker, and the piezoelectric speaker is separated from the vibration film.

9. The dual audio earphone as claimed in claim 7, wherein the holder includes a mounting element secured in the second chamber of the holder and defined between the dynamic speaker and the piezoelectric speaker so as to retain with the piezoelectric speaker, and the piezoelectric speaker is separated from the vibration film.

10. The dual audio earphone as claimed in claim 8, wherein the mounting element is annular and contacts with an inner surface of the peripheral fence of the holder.

11. The dual audio earphone as claimed in claim 9, wherein the mounting element is annular and contacts with an inner surface of the peripheral fence of the holder.

12. The dual audio earphone as claimed in claim 1, wherein the piezoelectric speaker includes a protective cap and at least one piezoelectric ceramic element, the protective cap is retained in the opening of the holder and flushes with the opening, a profile of the protective cap corresponds to the opening, and the at least one piezoelectric ceramic element is housed in the opening, wherein the protective cap has multiple apertures which are arranged around the at least one piezoelectric ceramic element and are symmetrical to a central position of the piezoelectric speaker.

13. The dual audio earphone as claimed in claim 4, wherein the piezoelectric speaker includes a protective cap and at least one piezoelectric ceramic element, the protective cap is retained in the opening of the holder and flushes with the opening, a profile of the protective cap corresponds to the opening, and the at least one piezoelectric ceramic element is housed in the opening, wherein the protective cap has multiple apertures which are arranged around the at least one piezoelectric ceramic element and are symmetrical to a central position of the piezoelectric speaker.

14. The dual audio earphone as claimed in claim 1, wherein the second chamber has a first end proximate to the opening and has a second end opposite to the first end of the second chamber, and a diameter of the first end of the second chamber is greater than that of the second end of the second chamber.
